(19) United States
(12) Patent Application Publication
(10) Pub. No.: US 2022/0357270 A1
(43) Pub. Date: Nov. 10, 2022

(54) ONLINE COLOR DIFFERENCE DETECTION SYSTEM AND DETECTION METHOD

(71) Applicant: WUHAN IRON AND STEEL COMPANY LIMITED, Hubei (CN)

(72) Inventor: Xiaozhou ZHOU, Hubei (CN)

(73) Assignee: WUHAN IRON AND STEEL COMPANY LIMITED, Hubei (CN)

(21) Appl. No.: 17/764,986

(22) PCT Filed: Mar. 24, 2021
(86) PCT No.: PCT/CN2021/082741

§ 371 Date: Mar. 30, 2022

(30) Foreign Application Priority Data
Aug. 17, 2020 (CN) 202010825184.0
Aug. 17, 2020 (CN) 202021716198.0

(51) Int. Cl. G01N 21/27; G01N 21/25

(52) U.S. Cl. CPC G01N 21/274; G01N 21/251

(57) ABSTRACT

The present invention discloses an online color difference detection system and detection method, and belongs to the color difference detection field, the system including: an online non-contact colorimeter and a bracket, the online non-contact colorimeter being located on the bracket, and the online non-contact colorimeter emitting a light source directed towards a sample under detection to perform color difference detection on the sample under detection, wherein an angle between reflected light received by a reflected light meter of the online non-contact colorimeter and a vertical line of the sample under detection has an error within plus or minus 1 degree from an angle between reflected light received by a reflected light meter of an offline benchtop colorimeter and the vertical line of the sample under detection.

### TECHNICAL FIELD

The present invention belongs to the color difference detection field, and more specifically, relates to an online color difference detection system and detection method.

### RELATED ART

With rapid development of the world economy and significant improvement of social living standards, people's diversified needs for commodities are more finely classified.

In metallurgy, papermaking, plastics, leather and cloth and other coiled material printing and dyeing industries, the determination of color difference between dyed coiled materials has considerable significance in industrial production. In particular, color difference between production plant products and standard samples is a core indicator of quality management.

In addition, common categories of color difference are front-to-back color difference, local color difference, color difference in a same batch of a coiled material, and color difference between different batches. There are currently three main indicator models for quantifying color in the world: CIE XYZ, Hunterlab lab and CIE l*a*b*, which are beginning to be adopted globally. Various color-related industries around the world cite the standards as quantification and determination indicators, for example, Hunterlab lab and CIE l*a*b* chromaticity space standards are used for all of EN13523, ASTMD2244, IS07724, JIS Z8730 and GB/T13448.

At present, all coiled material printing and dyeing industries in the world still use two forms to complete a color difference detection process by relying on human eyes and conducting local sampling using a professional colorimeter for contact offline measurement.

In the two forms, the human eye detection method must require a suitable environment and a light source that meets requirements, and also requires a rater to have normal vision, go through rigorous training, and have a wealth of experience in color recognition. In addition, human eyes are easily fatigued and susceptible to interference from a variety of factors, thus making a detected result often fail to meet requirements in most cases. Color difference detection is a kind of monotonous and heavy repetitive labor for workers, with high labor intensity. More critically, a detection result for both human eye detection and offline detection by a colorimeter will be affected by experience, proficiency and some subjective factors of an inspector, there is a lack of consistency and reliability, and the detection result is prone to cause contradictions and disputes between the upstream and downstream of the industry.

The other local sampling method is also a color difference standard release and arbitration method defined in various standards in the world at present. The automation degree for offline detection by local sampling of units is low, and the detection speed is slow, and the production cycle is increased. In addition, sampling representation is poor, which cannot reflect color difference indicators of all products.

The existing online devices have problems such as inconsistency between a measured value and a value of an offline benchtop colorimeter, data drift of the measured value, and inability to automatically calibrate, so the data can only be used as a display reference but cannot be used as detection data used for product detection release and recorded in a warranty.

Therefore, in order to meet the requirements of global industrial modernization, it is especially essential to study an online color difference detection system and method to promote the world online color difference detection technology.

### SUMMARY OF INVENTION

With respect to the above defects or improvement requirements in the prior art, the present invention provides an online color difference detection system and detection method. By adjusting an angle between reflected light received by a reflected light meter of an online non-contact colorimeter and a vertical line of a sample under detection to have an error within plus or minus 1 degree from an angle between reflected light received by a reflected light meter of an offline benchtop colorimeter and the vertical line of the sample under detection, detection data used for product detection release and recorded in a warranty is acquired.

To achieve the foregoing purpose, according to an aspect of the present invention, provided is an online color difference detection system, including: an online non-contact colorimeter and a bracket;

the online non-contact colorimeter being located on the bracket, and the online non-contact colorimeter emitting a light source directed towards a sample under detection to perform color difference detection on the sample under detection;

wherein an angle between reflected light received by a reflected light meter of the online non-contact colorimeter and a vertical line of the sample under detection has an error within plus or minus 1 degree from an angle between reflected light received by a reflected light meter of an offline benchtop colorimeter and the vertical line of the sample under detection.

Preferably, an inclined angle of the online non-contact colorimeter is adjusted, so that the angle between the reflected light received by the reflected light meter of the online non-contact colorimeter and the vertical line of the sample under detection has an error within plus or minus 1 degree from the angle between the reflected light received by the reflected light meter of the offline benchtop colorimeter and the vertical line of the sample under detection.

Preferably, the angle between the reflected light received by the reflected light meter of the online non-contact colorimeter and the vertical line of the sample under detection is the same as the angle between the reflected light received by the reflected light meter of the offline benchtop colorimeter and the vertical line of the sample under detection.

Preferably, the system further includes: an automatic calibration apparatus;

the automatic calibration apparatus is connected to the online non-contact colorimeter, and used for controlling the online non-contact colorimeter to move above a calibration standard sample in the automatic calibration apparatus according to a first preset period, so that the online non-contact colorimeter is calibrated by measured calibration standard sample data.

Preferably, the system further includes: an automatic standard sample apparatus;

the automatic standard sample apparatus is connected to the online non-contact colorimeter, and used for controlling the online non-contact colorimeter to move above the calibration standard sample in the automatic standard sample apparatus according to a second preset period, so that the online non-contact colorimeter updates a standard sample value by the measured calibration standard sample data.

Preferably, the automatic standard sample apparatus is used for controlling movement of the online non-contact colorimeter, so that the online non-contact colorimeter uses a light source to irradiate a standard sample, converts the sample into L₀, a₀ and b₀ values under the CIE LAB standard as standard sample data, and stores the standard sample data in standard sample values of a database.

Preferably, the online non-contact colorimeter is moved laterally on the bracket to perform multi-point continuous scanning detection on the moving sample under detection, uses a light source to irradiate the sample under detection, converts the sample into L, a and b values under the CIE LAB standard as measured values, and acquires a difference ΔL between an L value of the sample under detection and the standard sample value L₀, a difference Δa between an a value of the sample under detection and the standard sample value a₀, and a difference Δb between a b value of the sample under detection and the standard sample value b₀, respectively, obtains an average color difference ΔE from ΔE=(ΔL²+Δa²+Δb²)^{1/2}, and determines whether the sample under detection is qualified according to relationship between the average color difference ΔE and a preset threshold value.

Preferably, the online non-contact colorimeter is further used for sending an alarm signal when an average color difference of any one area of the sample under detection exceeds the preset threshold value, and recording color difference information and lateral and longitudinal coordinates of the area at the same time.

Preferably, the online non-contact colorimeter is further used for storing the color difference information of the sample under detection in the database for the convenience of information query.

According to another aspect of the present invention, provided is an online color difference detection method, including:

adjusting an angle between reflected light received by a reflected light meter of an online non-contact colorimeter and a vertical line of a sample under detection, so that the angle between the reflected light received by the reflected light meter of the online non-contact colorimeter and the vertical line of the sample under detection has an error within plus or minus 1 degree from an angle between reflected light received by a reflected light meter of an offline benchtop colorimeter and the vertical line of the sample under detection;

emitting a light source directed towards the sample under detection by the online non-contact colorimeter to perform color difference detection on the sample under detection.

Preferably, the method further includes:

controlling, by means of an automatic calibration apparatus, the online non-contact colorimeter to move above a calibration standard sample in the automatic calibration apparatus according to a first preset period, so that the online non-contact colorimeter is calibrated by measured calibration standard sample data.

Preferably, the method further includes:

controlling, by means of an automatic standard sample apparatus, the online non-contact colorimeter to move above the calibration standard sample in the automatic standard sample apparatus according to a second preset period, so that the online non-contact colorimeter updates a sample value by the measured calibration standard sample data.

In general, by the above technical solutions conceived in the present invention, compared with the prior art, the following beneficial effects can be achieved:

(1) by adjusting an angle between reflected light received by a reflected light meter of an online non-contact colorimeter and a vertical line of a sample under detection to have an error within plus or minus 1 degree from an angle between reflected light received by a reflected light meter of an offline benchtop colorimeter and the vertical line of the sample under detection, a measured value of the online non-contact colorimeter and a measured value of the offline benchtop colorimeter meet error requirements, which improves accuracy of the measured value, and then detection data used for product detection release and recorded in a warranty is acquired;

(2) the use of an automatic calibration apparatus enables the online non-contact colorimeter during measurement to be periodically calibrated to significantly improve the accuracy of the measured value;

(3) by means of an automatic standard sample device, the online non-contact colorimeter can periodically measure corresponding standard sample data during measurement, and constantly refresh a standard sample value in the system, so drift directions of the standard sample value and a measured value are the same, which solves the problem of data drift of the measured value and can greatly improve the accuracy of the measured value; and

(4) by means of the present invention, an online color difference detection system and method that can be used for standard detection for product release are implemented and integrated, accurate and continuous effective color difference value detection on a product may be implemented, thus improving accuracy and objectivity of product quality monitoring and release, and reducing manual labor intensity.

### BRIEF DESCRIPTION OF DRAWINGS

FIG. 1 is a schematic diagram of a structure of an online color difference detection system provided by embodiments of the present invention;

FIG. 2 is a schematic diagram of angle adjustment and calibration of an online non-contact colorimeter provided by embodiments of the present invention;

FIG. 3 is a schematic diagram of a structure of an online color difference detection system provided by embodiments of the present invention; and

FIG. 4 is a schematic diagram of a process of an online color difference detection method provided by embodiments of the present invention,

wherein 1 is an online non-contact colorimeter, 2 is a traverse moving beam, 3 is a column, 4 is a continuously moving sample under detection, 5 is an automatic calibration apparatus, 6 is an automatic standard sample apparatus, 7 is an offline benchtop colorimeter, 8 is a light source of a colorimeter, 9 is a reflected light meter, and 10 is reflected light of a sample.

### DESCRIPTION OF EMBODIMENTS

To further clarify the purpose, technical solutions and advantages of the present invention, the present invention will be further described in detail below in conjunction with the drawings and embodiments. It should be understood that the specific embodiments described herein are only used to explain the present invention, but not to limit the present invention. In addition, the technical features involved in the embodiments of the present invention described below can be combined with each other as long as they do not constitute a conflict therebetween.

In the embodiments of the present invention, “first”, “second”, etc. are used to distinguish different objects and need not be used to describe a particular order or sequence.

### Embodiment 1

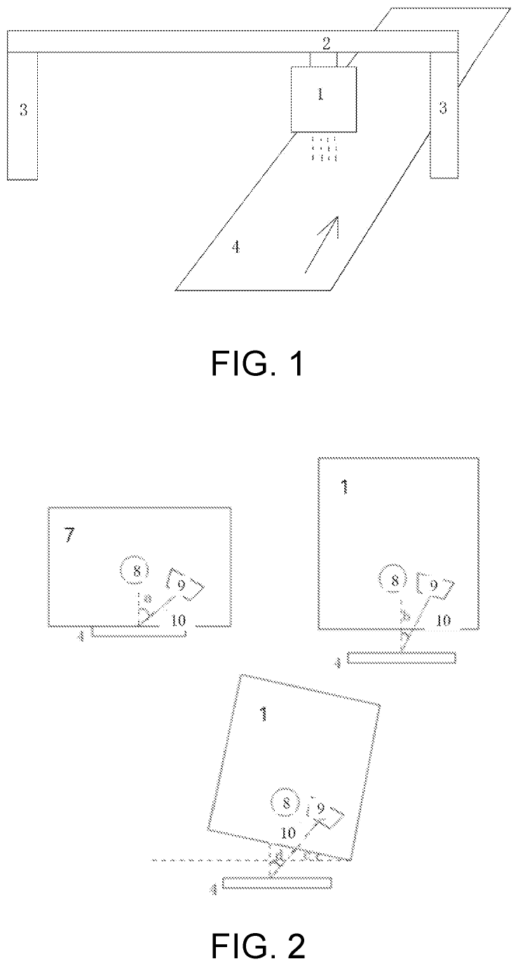

FIG. 1 shows a schematic diagram of a structure of an online color difference detection system provided by embodiments of the present invention, the system including: an online non-contact colorimeter 1 and a bracket;

the online non-contact colorimeter 1 being located on the bracket, and the online non-contact colorimeter 1 emitting a light source directed towards a sample 4 under detection, and the online non-contact colorimeter 1 moving laterally on the bracket to perform color difference detection on the sample 4 under detection.

As a preferred implementation manner, as shown in FIG. 1, the bracket includes: a traverse moving beam 2 and columns 3, wherein the columns 3 are used for supporting the traverse moving beam 2, and the online non-contact colorimeter 1 is mounted on the traverse moving beam 2 and can be moved laterally on the traverse moving beam 2.

As shown in FIG. 2, an angle between reflected light 10 received by a reflected light meter 9 of an online non-contact colorimeter 1 and a vertical line of a sample 4 under detection has an error within plus or minus 1 degree from an angle between reflected light received by a reflected light meter of an offline benchtop colorimeter 7 and the vertical line of the sample 4 under detection.

Further, an inclined angle of the online non-contact colorimeter 1 is adjusted, so that the angle between the reflected light received by the reflected light meter 9 of the online non-contact colorimeter 1 and the vertical line of the sample 4 under detection has the error within plus or minus 1 degree from the angle between the reflected light received by the reflected light meter of the offline benchtop colorimeter 7 and the vertical line of the sample 4 under detection.

Furthermore, the inclined angle of the online non-contact colorimeter 1 is adjusted, so that the angle between the reflected light received by the reflected light meter 9 of the online non-contact colorimeter 1 and the vertical line of the sample 4 under detection is the same as the angle between the reflected light received by the reflected light meter of the offline benchtop colorimeter 7 and the vertical line of the sample 4 under detection.

In this embodiment of the present invention, the online non-contact colorimeter 1 uses an LED light source 8 to irradiate a sample, and the reflected light meter 9 receives reflected light from the sample under detection. A lens inside the online non-contact colorimeter 1 collects the reflected light and directs same to a diffraction grating, which divides the received reflected light into different groups of light with different wavelengths, and the scattered light is measured by a silicon diode matrix and converted into useful color data.

In this embodiment of the present invention, FIG. 2 shows a schematic diagram of angle adjustment and calibration of an online non-contact colorimeter. The measured value of an offline benchtop colorimeter is currently used as the industry standard, and the online non-contact colorimeter is adjusted and calibrated according to an angle of the offline benchtop colorimeter specified in the national standard. To ensure that measured data of the online non-contact colorimeter 1 and measured data of the offline benchtop colorimeter 7 meet error requirements, by the online color difference detection system used for standard detection for product release, the angle between reflected light 10 received by the reflected light meter 9 of the online non-contact colorimeter 1 and the vertical line of the sample 4 under detection is adjusted to have an error within plus or minus 1 degree from an angle between reflected light received by the reflected light meter of the offline benchtop colorimeter 7 and the vertical line of the sample 4 under detection. For example, if a difference between the angle between the reflected light received by the reflected light meter 9 of the offline benchtop colorimeter 7 and the vertical line of the sample 4 under detection and the angle between the reflected light received by the reflected light meter 9 of the online non-contact colorimeter 1 and the vertical line of the sample 4 under detection is relatively large, an angle of a machine head of the online non-contact colorimeter 1 needs to be adjusted to make the error within plus or minus 1 degree. As shown in FIG. 2, a specific adjustment amount is: angle C=angle a−angle b, so that angle d=angle a±1°.

That is, an angle of the online non-contact colorimeter 1 is adjusted, so that the angle between the reflected light received by the reflected light meter 9 of the online non-contact colorimeter 1 and the vertical line of the sample 4 under detection has the error within plus or minus 1 degree from the angle between the reflected light received by the reflected light meter 9 of the offline benchtop colorimeter 7 and the sample 4 under detection.

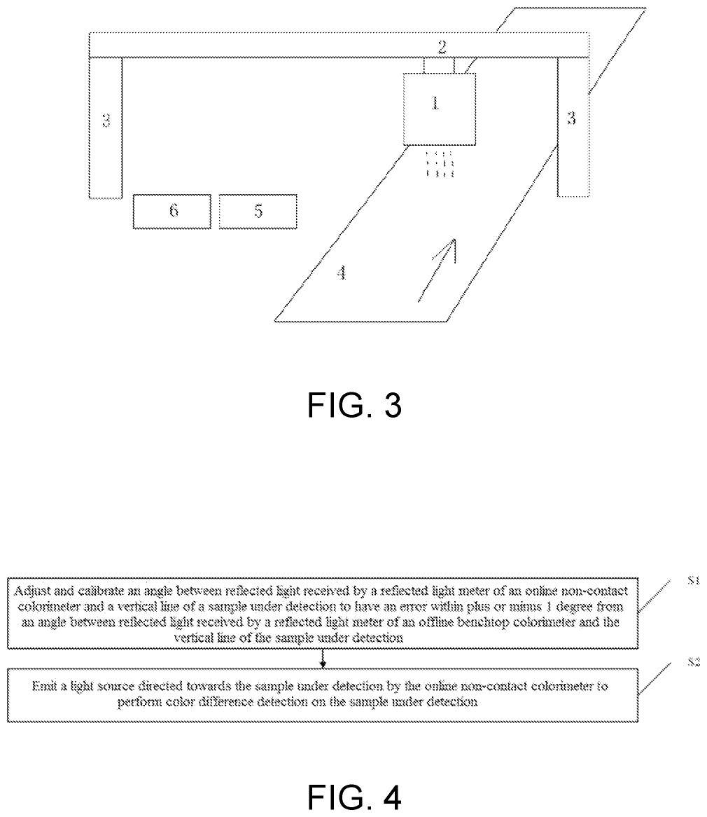

As shown in FIG. 3, the system further includes: an automatic calibration apparatus 5 and an automatic standard sample apparatus 6;

the automatic calibration apparatus 5 is connected to the online non-contact colorimeter 1, and used for controlling the online non-contact colorimeter 1 to move above a calibration standard sample in the automatic calibration apparatus 5 according to a first preset period, so that the online non-contact colorimeter 1 is calibrated by measured calibration standard sample data;

wherein, the first preset period can be determined according to actual requirements, and the embodiments of the present invention do not make unique definition. By setting variables such as how long an interval is or how many meters are detected, for every first preset period, the online non-contact colorimeter 1 is moved above the calibration standard sample in the automatic calibration apparatus 5, and the online non-contact colorimeter 1 collects calibration standard sample data, and then is calibrated by the measured calibration standard sample data.

In this embodiment of the present invention, the automatic calibration apparatus 5 enables the online non-contact colorimeter 1 to be calibrated periodically to correct measurement accuracy of the machine head of the online non-contact colorimeter 1.

The automatic standard sample apparatus 6 is connected to the online non-contact colorimeter 1, and used for controlling the online non-contact colorimeter 1 to move above the calibration standard sample in the automatic standard sample apparatus 6 according to a second preset period, so that the online non-contact colorimeter 1 updates a standard sample value by the measured calibration standard sample data,

and the second preset period can be determined according to actual requirements, and the embodiments of the present invention do not make unique definition. By setting variables such as how long an interval is or how many meters are detected, for every first preset period, the online non-contact colorimeter 1 is moved above the calibration standard sample in the automatic standard sample apparatus 6, and the online non-contact colorimeter 1 collects calibration standard sample data, and then refreshes original standard sample data according to the measured calibration standard sample data.

The automatic standard sample apparatus 6 enables a standard sample value to be updated periodically to correct measurement accuracy of the online non-contact colorimeter 1.

In this embodiment of the present invention, extraction of color features and calculation of color differences can be based on a CIE LAB color space model. CIE LAB uses L, a and b coordinate axes to define a CIE color space, and all colors can be represented by three values L, a and b, wherein L represents a lightness index (a brightness axis) which indicates black and white, 0 for black, 100 for white, and 0-100 for gray; a represents a color index (a red-green axis), positive values for red and negative values for green; and b represents a color index (a yellow-blue axis), positive values for yellow and negative values for blue.

In this embodiment of the present invention, the automatic standard sample apparatus 6 is used for controlling movement of the online non-contact colorimeter, so that the online non-contact colorimeter uses an LED light source to irradiate a standard sample, converts the sample into L₀, a₀ and b₀ values under the CIE LAB standard as standard sample data, and stores the standard sample data in standard sample values of a database.

In this embodiment of the present invention, the online non-contact colorimeter 1 performs multi-point continuous scanning detection on a moving sample under detection, uses an LED light source to irradiate the sample under detection, converts the sample into L, a and b values under the CIE LAB standard as measured values, and acquires a difference ΔL between an L value of the sample under detection and the standard sample value L₀, a difference Δa between an a value of the sample under detection and the standard sample value a₀, and a difference Δb between a b value of the sample under detection and the standard sample value b₀, respectively, obtains an average color difference ΔE from ΔE=(ΔL²+Δa²+Δb²)^{1/2}, and determines whether the sample under detection is qualified according to relationship between the average color difference ΔE and a preset threshold value.

The preset threshold value is a threshold value when a product is set to be qualified, which can be set according to an actual situation.

Further, the online non-contact colorimeter 1 is further used for sending an alarm signal when an average color difference of any one area of the sample 4 under detection exceeds the preset threshold value, and recording color difference information and lateral and longitudinal coordinates of the area at the same time.

Further, the online non-contact colorimeter 1 is further used for storing the color difference information of the sample 4 under detection in a database for the convenience of information query.

By means of the present invention, an online color difference detection system and method that can be used for standard detection for product release are implemented and integrated, accurate and continuous effective color difference value detection on a product may be implemented, thus improving accuracy and objectivity of product quality monitoring and release, and reducing manual labor intensity.

### Embodiment 2

FIG. 4 is a schematic diagram of a process of an online color difference detection method provided by an embodiment of the present invention, the method including:

S1: an angle between reflected light received by a reflected light meter of an online non-contact colorimeter 1 and a vertical line of a sample 4 under detection is adjusted and calibrated to have an error within plus or minus 1 degree from an angle between reflected light received by a reflected light meter of an offline benchtop colorimeter 7 and the vertical line of the sample 4 under detection; and

S2: a light source emitted from the online non-contact colorimeter 1 directs towards the sample 4 under detection to perform color difference detection on the sample 4 under detection.

Further, the method further includes:

by means of an automatic calibration apparatus 5, the online non-contact colorimeter 1 is controlled to move above a calibration standard sample in the automatic calibration apparatus 5 according to a first preset period, so that the online non-contact colorimeter 1 is calibrated by measured calibration standard sample data.

Further, the method further includes:

by means of an automatic standard sample apparatus 6, the online non-contact colorimeter 1 is controlled to move above the calibration standard sample in the automatic standard sample apparatus 6 according to a second preset period, so that the online non-contact colorimeter 1 updates a standard sample value by the measured calibration standard sample data.

In this embodiment of the present invention, the automatic standard sample apparatus 6 is used for controlling movement of the online non-contact colorimeter 1, so that the online non-contact colorimeter 1 uses an LED light source to irradiate a standard sample, converts the sample into L₀, a₀ and b₀ values under the CIE LAB standard as standard sample data, and stores the standard sample data in standard sample values of a database.

In this embodiment of the present invention, the online non-contact colorimeter 1 performs multi-point continuous scanning detection on a moving sample under detection, uses an LED light source to irradiate the sample under detection, converts the sample into L, a and b values under the CIE LAB standard as measured values, and acquires a difference ΔL between an L value of the sample under detection and the standard sample value L₀, a difference Δa between an a value of the sample under detection and the standard sample value a₀, and a difference Δb between a b value of the sample under detection and the standard sample value b₀, respectively, obtains an average color difference ΔE from ΔE=(ΔL²+Δa²+Δb2)^{1/2}, and determines whether the sample under detection is qualified according to relationship between the average color difference ΔE and a preset threshold value.

In this embodiment of the present invention, the method further includes: the online non-contact colorimeter 1 sends an alarm signal when an average color difference of any one area of the sample under detection exceeds the preset threshold value, and records color difference information and lateral and longitudinal coordinates of the area at the same time.

In this embodiment of the present invention, the method further includes: the online non-contact colorimeter 1 stores the color difference information of the sample under detection in a database for the convenience of information query.

By means of the present invention, an online color difference detection method that can be used for standard detection for product release is implemented and integrated, accurate and continuous effective color difference value detection on a product may be implemented, thus improving accuracy and objectivity of product quality monitoring and release, and reducing manual labor intensity.

### Embodiment 3

A steel company cold rolling mill C409 color coating unit performs online testing according this solution, and tests a total of hundreds of colors, a material runs stably at speeds of 30-230 m/min, the equipment operating stability is 99.5% or above, and compared with a sampling offline detection room, measured values meet the accuracy range required in EN13523, ASTM D2244, ISO7724, JIS Z8730 and GB/T13448. A measurement repeatability ΔE fluctuates less than 0.1. An error between the measurement repeatability ΔE and product release measurement ΔE of an offline detection room is less than 0.2, thus achieving a technological disruptive breakthrough in this field. The system is less disturbed by an external environment and has the advantages of high detection accuracy, fast speed and good stability. Experimental results are shown in Table 1 below.

TABLE 1

| | | | | | | | | | Deviation |
|---|---|---|---|---|---|---|---|---|---|
| | | | | | | | | | From a |
| | Benchtop Device | | | | Online Device | | | | Detection |
| Color Type | 1 | a | b | ΔE | 1 | a | b | ΔE | Room |
| Aqua Blue | 34.95 | −9.67 | −39.57 | | 49.34 | −16.07 | −51.00 | | |
| Standard | | | | | | | | | |
| Sample* | | | | | | | | | |
| Aqua Blue | 35.2 | −9.76 | −39.46 | 0.29 | 49.34 | −15.84 | −51.17 | 0.29 | |
| Specimen | | | | | | | | | |
| Difference | 0.25 | −0.09 | 0.11 | | 0.00 | 0.23 | −0.17 | | |
| Analysis | | | | | | | | | |
| | Volume No. 911655175 | | | 0.29 | Volume No. 911655175 | | | 0.29 | 0 |
| | Detection Room Up | | | | Online Device Data | | | | |
| | Throw Data | | | | | | | | |
| Aqua Blue | 34.95 | −9.67 | −39.57 | | 49.99 | −15.74 | −51.02 | | |
| Standard | | | | | | | | | |
| Sample* | | | | | | | | | |
| Aqua Blue | 35.09 | −9.71 | −39.43 | 0.2 | 49.91 | −15.99 | −50.94 | 0.27 | |
| Specimen | | | | | | | | | |
| Difference | 0.14 | −0.04 | 0.14 | | −0.08 | −0.25 | 0.08 | | |
| Analysis | | | | | | | | | |
| | Volume No. 93833911 | | | 0.2 | Volume No. 93833911 | | | 0.27 | 0.07 |
| | Detection Room Up | | | | Online Device Data | | | | |
| | Throw Data | | | | | | | | |
| Aqua Blue | 34.95 | −9.67 | −39.57 | | 49.38 | −15.96 | −51.33 | | |
| Standard | | | | | | | | | |
| Sample* | | | | | | | | | |
| Aqua Blue | 35.5 | −9.84 | −39.5 | 0.58 | 49.76 | −16.14 | −51.79 | 0.62 | |
| Specimen | | | | | | | | | |
| Difference | 0.55 | −0.17 | 0.07 | | 0.38 | −0.18 | −0.46 | | |
| Analysis | | | | | | | | | |
| | Volume No. 93173648 | | | 0.58 | Volume No. 93173648 | | | 0.62 | 0.04 |
| | Detection Room Up | | | | Online Device Data | | | | |
| | Throw Data | | | | | | | | |
| Aqua Blue | 34.95 | −9.67 | −39.57 | | 48.56 | −15.62 | −50.91 | | |
| Standard | | | | | | | | | |
| Sample* | | | | | | | | | |
| Aqua Blue | 34.4 | −9.88 | −38.96 | 0.65 | 48.33 | −15.91 | −50.38 | 0.65 | 0.00 |
| Specimen | | | | | | | | | |
| Difference | −0.55 | −0.21 | 0.61 | | −0.23 | −0.29 | 0.53 | | |
| Analysis | | | | | | | | | |
| | Volume No. 03002842 | | | | Volume No. 03002842 | | | | |
| | Detection Room Up | | | | Online Device Data | | | | |
| | Throw Data | | | | | | | | |
| Aqua Blue | 34.95 | −9.67 | −39.57 | | 48.70 | −15.82 | −50.96 | | |
| Standard | | | | | | | | | |
| Sample* | | | | | | | | | |
| Aqua Blue | 35.05 | −9.9 | −38.92 | 0.69 | 48.55 | −16.44 | −51.04 | 0.64 | −0.05 |
| Specimen | | | | | | | | | |
| Difference | 0.1 | −0.23 | 0.65 | | −0.15 | −0.62 | −0.08 | | |
| Analysis | | | | | | | | | |

| | |
|---|---|
| Volume No. 02030691 | Volume No. 02030691 |
| Detection Room Up | Online Device Data |
| Throw Data | |

In Table 1, Aqua Blue Standard Sample* is a standard sample value, Aqua Blue Specimen is a sample under detection. The error ΔE obtained using the online color difference detection system of the present invention fluctuates less than 0.1 from the error ΔE of the offline device, which meets a release standard of less than 0.2 between the product release measurement ΔE in the offline detection room.

It should be noted that individual steps/components described in the present application may be split into more steps/components, or two or more steps/components or partial operations of steps/components may be combined into new steps/components, according to requirements for implementation, to achieve the purpose of the present invention.

Those skilled in the art can easily understand that the foregoing descriptions are only preferred embodiments of the present invention, but are not intended to limit the present invention. Any modification, equivalent replacement and improvement made within the spirit and principle of the present invention shall be included in the protection scope of the present invention.

1. An online color difference detection system, by comprising: an online non-contact colorimeter and a bracket,
the online non-contact colorimeter being located on the bracket, and the online non-contact colorimeter emitting a light source directed towards a sample under detection to perform a color difference detection on the sample under detection,
wherein an angle between a reflected light received by a reflected light meter of the online non-contact colorimeter and a vertical line of the sample under detection has an error within plus or minus 1 degree from an angle between a reflected light received by a reflected light meter of an offline benchtop colorimeter and the vertical line of the sample under detection.

2. The online color difference detection system according to claim 1, wherein an inclined angle of the online non-contact colorimeter is adjusted, so that the angle between the reflected light received by the reflected light meter of the online non-contact colorimeter and the vertical line of the sample under detection has the error within plus or minus 1 degree from the angle between the reflected light received by the reflected light meter of the offline benchtop colorimeter and the vertical line of the sample under detection.

3. The online color difference detection system according to claim 1, wherein the angle between the reflected light received by the reflected light meter of the online non-contact colorimeter and the vertical line of the sample under detection is the same as the angle between the reflected light received by the reflected light meter of the offline benchtop colorimeter and the vertical line of the sample under detection.

4. The online color difference detection system according to claim 3, further comprising: an automatic calibration apparatus, wherein
the automatic calibration apparatus is connected to the online non-contact colorimeter, and used for controlling the online non-contact colorimeter to move above a calibration standard sample in the automatic calibration apparatus according to a first preset period, so that the online non-contact colorimeter is calibrated by a measured calibration standard sample data.

5. The online color difference detection system according to claim 4, further comprising: an automatic standard sample apparatus, wherein
the automatic standard sample apparatus is connected to the online non-contact colorimeter, and used for controlling the online non-contact colorimeter to move above the calibration standard sample in the automatic standard sample apparatus according to a second preset period, so that the online non-contact colorimeter updates a standard sample value by the measured calibration standard sample data.

6. The online color difference detection system according to claim 2, wherein the online non-contact colorimeter is moved laterally on the bracket to perform a multi-point continuous scanning detection on the moving sample under detection, uses the light source to irradiate the sample under detection, converts the sample into L, a and b values under the CIE LAB standard as measured values, and acquires a difference ΔL between an L value of the sample under detection and a standard sample value L₀, a difference Δa between an a value of the sample under detection and a standard sample value a₀, and a difference Δb between a b value of the sample under detection and a standard sample value b₀, respectively, obtains an average color difference ΔE from ΔE=(ΔL²+Δa²+Δb²)^{1/2}, and determines whether the sample under detection is qualified according to relationship between the average color difference ΔE and a preset threshold value.

7. The online color difference detection system according to claim 6, wherein the online non-contact colorimeter is further used for sending an alarm signal when an average color difference of any one area of the sample under detection exceeds the preset threshold value, and recording a color difference information and lateral and longitudinal coordinates of the area at the same time.

8. An online color difference detection method, comprising:
adjusting an angle between a reflected light received by a reflected light meter of an online non-contact colorimeter and a vertical line of a sample under detection, so that the angle between the reflected light received by the reflected light meter of the online non-contact colorimeter and the vertical line of the sample under detection has an error within plus or minus 1 degree from an angle between a reflected light received by a reflected light meter of an offline benchtop colorimeter and the vertical line of the sample under detection; and
emitting a light source directed towards the sample under detection by the online non-contact colorimeter to perform a color difference detection on the sample under detection.

9. The online color difference detection method according to claim 8, further comprising:
controlling, by means of an automatic calibration apparatus, the online non-contact colorimeter to move above a calibration standard sample in the automatic calibration apparatus according to a first preset period, so that the online non-contact colorimeter is calibrated by a measured calibration standard sample data.

10. The online color difference detection method according to claim 9, further comprising:
controlling, by means of an automatic standard sample apparatus, the online non-contact colorimeter to move above the calibration standard sample in the automatic standard sample apparatus according to a second preset period, so that the online non-contact colorimeter updates a standard sample value by the measured calibration standard sample data.

11. The online color difference detection system according to claim 2, wherein the angle between the reflected light received by the reflected light meter of the online non-contact colorimeter and the vertical line of the sample under detection is the same as the angle between the reflected light received by the reflected light meter of the offline benchtop colorimeter and the vertical line of the sample under detection.
